(19) United States
(12) Patent Application Publication
(10) Pub. No.: US 2015/0381737 A1
(43) Pub. Date: Dec. 31, 2015

(54) GATEWAY DEVICE AND A GATEWAY SYSTEM FOR AN INTERNET-OF-THINGS ENVIRONMENT

(71) Applicant: Davra Networks Limited, Dublin (IE)

(72) Inventors: Joseph Anthony Quinn, Tubbercurry (IE); Colin Francis Ryan, Dublin (IE); Brian Michael McGlynn, Dublin (IE)

(73) Assignee: DAVRA NETWORKS LIMITED, Dublin (IE)

(21) Appl. No.: 14/319,613

(22) Filed: Jun. 30, 2014

(51) Int. Cl. H04L 29/08; G06F 17/30

(52) U.S. Cl. CPC H04L 67/12; G06F 17/30575; H04L 67/1095; H04L 67/02

(57) ABSTRACT

A gateway device is disclosed for use in an internet-of-things environment. The gateway device comprises a sensor interface for interfacing with a plurality of sensors. A first memory unit is provided for storing sensed data received from the sensors. A second memory unit is provided for storing template data associated with the sensors which is generated by the sensor interface. A processing module is configured for generating encoded messages associated with the respective sensors containing the sensed data and the template data. A communication module is operable for communicating the encoded messages to a central server for decoding.

### FIELD OF THE INVENTION

The present teaching relates to an internet of things gateway device and a gateway system for an internet-of-things environment.

### BACKGROUND

The Internet of Things (IoT) concept refers to uniquely identifiable objects and their virtual representations in an Internet type system. IoT gateway devices are use to obtain data from legacy devices thereby generating intelligence from legacy devices. Today the Internet-of-Things industry is being stifled by unstandardised protocols. There are a vast amount of legacy sensors that are communicating in multiple different protocols.

There are a plethora of sensors and sensor protocols in the field and in production. The communication protocol they support is not standardised. There are many competing attempts to standardise these protocols such as MQTT, CoAP, JMS. There is also a lot of legacy devices in the field that are analog or have proprietary communication protocols. This is satisfactory when creating a point to point application that is built to talk to a single sensor type but if you want to build an IoT platform that can communicate with any sensor the use of multiple protocols is a major obstacle.

There is therefore a need for a gateway device which addresses at least some of the drawbacks of the prior art.

### SUMMARY

In one aspect there is provided a gateway device for an internet-of-things environment; the gateway comprises:

a sensor interface for interfacing with a plurality of sensors;

a first memory unit for storing sensed data received from the sensors;

a second memory unit for storing template data associated with the sensors which is generated by the sensor interface;

a processing module configured for generating encoded messages associated with the respective sensors containing the sensed data and the template data; and

a communication module for communicating the encoded messages to a central server for decoding.

In another aspect, the contents of the first memory unit is deleted during a reboot of the gateway device.

In a further aspect, the contents of the second memory unit is retained during a reboot of the gateway device.

In one aspect, the processing module is further configured for comparing current sensor data against previous sensor data stored in the first memory unit for determining output data. Advantageously, the comparison step is implemented in real-time.

In another aspect, the encoded messages contain the output data. Advantageously, the encoded messages are compatible with an internet protocol flow information export (IPFIX) format.

In one aspect, the sensor interface is configured to interrogate the sensors for retrieving sensed data therefrom. In an exemplary arrangement, the sensor interface is configured to listen for data output by the sensor.

In another aspect, the sensor interface is operable to receive driver data from the sensors.

In one aspect, the sensor interface comprises a plurality of interface modules for interfacing with a plurality of sensors.

In a further aspect, two or more of the interface modules are configured for communicating with sensors having different communication protocols.

In one exemplary arrangement, the respective interface modules comprise a binary library.

In one example, the respective interface modules comprise a script.

In another example, the respective interface modules are configurable for facilitating writing data thereto. Advantageously, the respective interface modules retrieve raw sensor data from corresponding sensors.

In a further aspect, the respective interface modules pass the raw sensor data into their associated binary library via an application programming interface. In one exemplary arrangement the respective interface modules pass the raw sensor data into their associated script. Advantageously, the respective interface modules publish the raw sensor data and template data to a discovery layer.

In one aspect, the template data for the respective sensors are provided in corresponding descriptor files.

In another aspect, the respective descriptor files include one or more of the following pieces of data type, units, labels, and descriptive text.

In one aspect, the template data has an associated identifier for each sensor value. Advantageously, the encoded messages are communicated to the central server using a hypertext transfer protocol (HTTP) or HTTP secure (HTTPS).

In another aspect, the processing module is operable to receive information from multiple interface modules each communicable with a corresponding sensor.

In one aspect, the processing module is configured to selectively filter raw sensor data for determining the output data. Advantageously, the output data includes only sensor values which have changed since a previous sensor reading.

In a further aspect, encoded messages are synchronised with a remote central database at predetermined time intervals.

In another aspect, the processing module has associated configuration data. Advantageously, the configuration data includes threshold values for determining when to generate alerts.

In one aspect, the configuration data includes a time schedule for determining how regularly to synchronise the encoded messages with the central database. Advantageously, the configuration data includes information for determining when to synchronise the encoded messages with the central database.

In one aspect, the configuration data includes details of specific actions to implement if a threshold is exceeded.

In a further aspect, a predictive analysis module provides an intelligent service for predicting issues with sensors.

In an exemplary arrangement, a thresholding parameters module is configured to compare raw sensor data against threshold values. Advantageously, the thresholding parameters module generates an appropriate alert message if a threshold value is exceeded.

In one aspect, the communication module is configured to transmit the generated alert message to the central server for initiating a course of actions.

In a further aspect, the communication module is operable to monitor the signal strength of a cellular network. Advantageously, if the signal strength deviates below an acceptable level the output data is buffered until the signal strength increases above the acceptable level. In one example, the output data is buffered in the first memory unit.

In another aspect, the first memory unit includes a mechanism for preventing the information contained therein exceeding a limit. Advantageously, the mechanism deletes data in the first unit if the buffered output data exceeds the limit. Preferably, the mechanism deletes data according to a set of priority rules.

In a further aspect, the communication module includes a subscriber identify module.

In one example, the communication module is operable to select an access point name (APN) for communicating the gateway device and the central server.

In one aspect, the communication module is operable to send data to the central server via a short message service (SMS).

In a further aspect, the encoded messages contain a flag to indicate that an acknowledgement is required when received at the central server. Advantageously, the communication module is configured to resend the encoded message if an acknowledgement is not received from the central server within a predetermined time limit.

The present teaching is also directed to a central server for an internet-of-things environment; the central server comprising:

a gateway interface for interfacing with a plurality of gateway devices;

a central database comprising records of sensors associated with the respective gateway devices; the records including sensed data and template data received from the respective gateway devices;

a synchronisation module configured for facilitating the synchronisation of the central database with the respective gateway devices; and

a processing module for controlling the respective gateway devices.

In one aspect, the gateway interface is configured to decode the output data received from the respective gateway devices.

In another aspect, the gateway interface is operable to parse IPFIX messages received from the respective gateway devices.

In a further aspect, a predictive analysis module is configured to compare data patterns for predicting sensor faults. Advantageously, the processing module is operable to transmit updates to the respective gateway devices if a sensor fault is predicted.

In one example the central server is provided on a cloud.

The present disclosure also relates to an internet-of-things (IoT) system comprising:
a plurality of gateway devices which comprise
   a sensor interface for communicating with a plurality of sensors;
   a local database for storing records associated with the respective sensors;
the records include sensed data and template data;
   a gateway synchronising module configured for synchronising the local database with a remote central database associated with a central server; and
   a communication module for communicating data between the gateway
   device and the central server,
      the IoT system further comprising:
a central server comprising:
   a gateway interface for interfacing with the plurality of gateway devices;
   a central database comprising records of sensors associated with the respective gateway devices; the records including sensed data and template data;
   a server synchronisation module being co-operable with the gateway synchronising module; and
   a controlling module for controlling the respective gateway devices.

These and other features will be better understood with reference to the followings Figures which are provided to assist in an understanding of the present teaching.

### BRIEF DESCRIPTION OF THE DRAWINGS

The present teaching will now be described with reference to the accompanying drawings in which:

FIG. 1 is block diagram representation of the internet of things system in accordance with the present teaching.

FIG. 2 is a flow chart illustrating steps for interfacing a gateway device of the system of FIG. 1 with a sensor.

FIG. 3 is diagrammatic illustration of an encoded message which is generated by the gateway device of FIG. 2.

FIG. 4 is a block diagram of the gateway device of FIG. 1.

### DETAILED DESCRIPTION OF THE DRAWINGS

The present disclosure will now be described with reference to an exemplary internet of things (IoT) system. It will be understood that the exemplary IoT system is provided to assist in an understanding of the present teaching and is not to be construed as limiting in any fashion. Furthermore, modules or elements that are described with reference to any one Figure may be interchanged with those of other Figures or other equivalent elements without departing from the spirit of the present teaching.

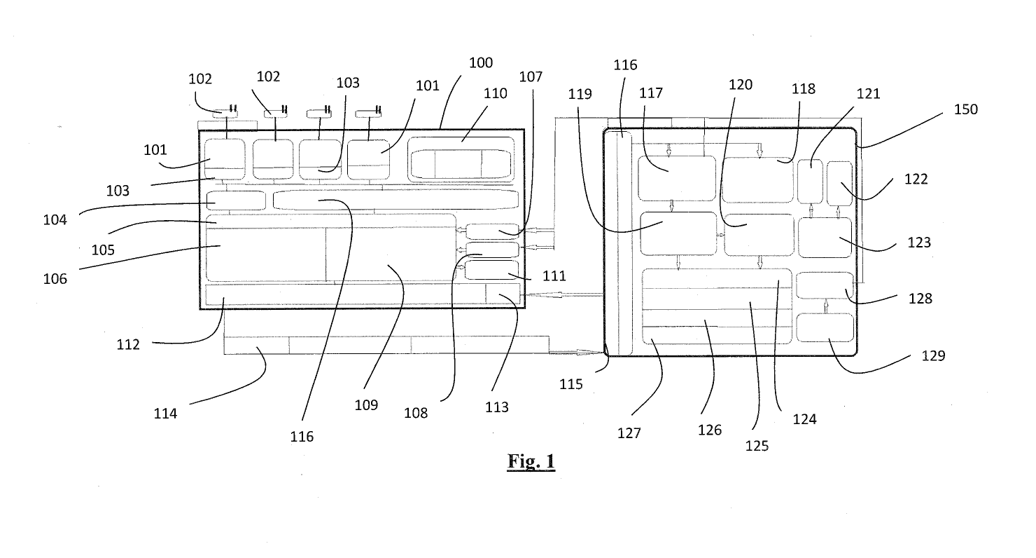

Referring to FIG. 1, there is provided an gateway device 100 for an internet-of-things environment. The gateway device 100 includes a gateway interface which is operable for communicating with a plurality of sensors 102. The gateway device 100 communicates with a central server 150 across a cellular network. The gateway device 100 is an intelligent device which talks to sensors 102 in order to retrieve sensor data which is then relayed to the central server 150 for analysis. The central server 150 is configured to monitor multiple gateway devices 100. The gateway device 110 comprises a processor which is programmed to implement on-board processing functions which are described in detail as follows.

The gateway interface includes a plurality of configurable interface modules 101 which interface with corresponding sensors 102. The interface modules 101 communicate with the sensors in order to retrieve raw sensor data therefrom. In an exemplary arrangement, each interface module 101 is programmed to obtain driver details from the sensor so that it can determine how to communicate with the sensor. The respective interface modules 101 are compatible with various communication protocols which allows the gateway interface to be able to communicate with sensors having different communication protocols. For example, one of the interface modules 101 is compatible with a first protocol and another one of the interface modules 1 may be compatible with a second protocol.

Each interface module 101 has an associated driver 103 which allows the interface modules 101 to be plugged into a processing module 105. The driver 103 may include a binary library or a software script containing a set of machine readable instructions. When the interface module 101 retrieves raw sensor data from the sensor 102 it passes the raw sensor data into the driver 103 through an exposed application programming interface. The interface modules 101 publishes the sensed data and template data associated with the sensed dated to a discovery layer 104. The template data may include semantics in the form of a descriptor file which may include details for each sensor 102 such as data type (int, long, string, float, double etc), units, label(s), descriptive text etc. The discovery layer 104 will then generate a unique template identifier (ID) for each sensor value and will synch this up to the central server 150 via a HTTPS post where they will be stored in a server database 122.

The processing module 105 is operable to receive information from multiple interface modules 101 each communicating with a different sensor 102. A flow inclusion module 106 is configured to operate as a filter to selectively determine what data should be relayed to the central server 150. In the exemplary arrangement, the flow inclusion module 106 by default will only send a sensor value if that value has changed since a previous sensor reading. For example, if the temperature of a sensor 102 is constant at 20 degrees then there is no need to repetitively send the same temperature value as to do so would consume bandwidth. The flow inclusion module 106 may be configured to send data periodically such as every 30 seconds. A database 107 stores configuration data for the processing module 105. The configuration data may include, for example, how often to send values and thresholds for when to generate alerts. Additionally, it may also contain information on what actions to run by the processing module 105 in the event that a threshold value is exceeded.

A predictive analysis module 108 provides an intelligent service for predicting potential issues with the sensors 102. The central server 150 may be configured to learn data patterns in order to identify patterns leading up to faults. The central server 150 can then send this control data to the gateway device 100 and update the logic so that it may detect issues earlier and create more intelligent alerts. A thresholding parameters module 109 compares the sensed values against threshold values. If a threshold value is exceeded an appropriate alert message is generated by the thresholding parameters module 109 and communicated back to the central server 150. In response to receiving the alert message the central server 150 initiates a course of action.

A communication module 110 monitors the quality of the cellular network and if the quality deviates below an acceptable level it will perform certain actions such as buffering output data until the signal strength improves. The output data may be buffered in a cache 111. The cache 111 buffers output data in the scenario when the cellular signal is too low for the data to be reliably uploaded to the central server 150. When the cellular signal improves the output data from the cache 111 it is relayed to the central server 150. The cache 111 has mechanisms built in to ensure that the information in the cache does not exceed a certain limit. If the size of the cached information exceeds the limit the cache is operable to delete messages according to priority. Low priority messages are dropped initially. Also any duplicate messages are deleted from the cache 111. The communication module 110 may include a subscriber identity module (sim). If appropriate, the communication module 110 may select an access point name (APN) for communicating the gateway device 100 and the central server 150. It can also communicate over a 2G network so that the information may be sent via SMS if it is critical.

An exporter module 112 takes the output information that is to be sent to the central server 150 and forms an encoded message. In the exemplary arrangement, the encoded message is an internet protocol flow information export (IPFIX) message 114. The IPFIX message 114 is then transmitted to the central server 150. Certain IPFIX messages 14 may include a flag which is added by an acknowledge module 113 indicating that an acknowledgment is necessary. In these cases the gateway device 100 will resend the message 114 if it does not receive an acknowledgement within a certain time period from the central server 150. The IPFIX message 114 may include a template ID's identifying the sensor values being sent. The message 114 may also includes sensor values and network quality statistics.

The central server 150 comprises a gateway interface 115 which is operable for receiving messages 114 from a plurality of gateway devices 100. The gateway interface 115 may be a highly scalable packet receiver which takes the IPFIX messages 114 off a network interface card and brings it into its memory. A template translation layer 116 is configured to parse the received IPFIX message 114 and direct the message towards database 122 along various messaging buses. The received sensor data decoded from the messages 114 is sent through a predictive analysis module 117 which is configured to compare current sensor patterns to previous sensor patterns which resulted in a fault to determine whether such patterns are occurring again. A storage processing modules 118 routes the sensor values to their record in the database 122. These values may be synchronised in real time with the values in the database 107 so that they are available for reporting in real time. An alerting module 119 receives an output from the predictive analysis module 117 to determine whether the current sensor value its outside a normal threshold range. If the current sensor value is outside the normal threshold range the alerting module 119 will generate an alert message. A baseline engine 120 receives the sensor information from the alerting module 119 and is configured to learn baselines for certain time periods such as what's a normal value for a sensor at a certain time of day during a particular week.

A sensor information store 121 stores the template data (semantics) for each sensor 102, this information is passed up from the interface module 101 on the gateway device 100 so that both the central server 150 is aware of the template data as well as the processing module 105 on the gateway device 100. The sensor information store 121 stores definition around each sensor relating to how real time the information needs to be for each sensor 102 and also what is normal operating conditions for this sensor 102. The sensor information store 121 may be manually updated by a user. Alternatively, the sensor information store 121 may be updated by the baseline engine 120 and the predictive analysis module 117. The sensor information store 121 is synced with the template store 107 on the gateway device 100.

A database stores 123 stores all the historical sensor information so that it can be retrieved later if desired. The database 123 is designed in such a way that information can be inserted in real time and is also available for reporting in real time. A reporting engine 124 is configured to generate reports. The reporting engine 124 feeds data to built in reports. For example, a standard set of reports may be built in for things like network quality statistics. An application builder engine 125 feeds into a framework where users can define their own reports and dashboards. All the sensors 102 discovered by the discovery layer 104 are made available here so that the user can easily select them for charting and reporting.

An API driver 126 feeds an open application programming interface. This is a representational state transfer (REST) web service and provides access to a distributed data store. An enterprise service bus 127 allows third parties to integrate with the server 150 by pushing information to them in the form of alerts etc. A layer 128 is configured for syncing information between the central server 150 and the gateway devices 100. It updates alerting parameters for sensor values on the IOT gateway devices 100. A template engine 129 interprets the database 107 and provides information to the layer 128 so that it knows how to sync information between the server 150 and the gateway device 100.

In operation, the gateway device 100 communicate to the sensors 102. The gateway device 100 has a processor on board for processing data. The processor is programmed to implement the functionality of each module described above. The interface module 101 initially calls through to the discovery module 104 via the driver 103. This call informs the processing module 105 of the sensors 102 that the interface module 101 is communicating and the semantics (template data) of those sensors 102. The semantics may include for example, name, description, units, data type, etc. The discovery module 104 passes this semantic information through to the processing module 105 and into the database 107. Information in the database 107 is automatically synced with the database 122 on the central server 150. When this process is complete the interface module 101 may use another call to start passing actual sensor data through to the processing module 105 and because the processing module 105 has access to the local database 107 it is able to create an appropriate record which is then incorporated into the encoded message 114 to export to the central server 150.

The encoded message 114 will then arrive at the gateway interface 115 on the central server 150 and because the server 150 has a database 122 which is a mirror image of the database 107 it has sufficient information to decode the encoded message 114 in order to retrieve the record. The record is then stored in the database 123. The database 107 is synchronised with the database 122 via a HTTP(S) put from the gateway device 100 to the server 150. This is triggered whenever a change to the database 107 is detected. The templates and data structures are defined using a standard called IPFIX. This standard was developed with the intent of retrieving information on traffic flowing through network devices. The novel use of this standard to send sensor values in the packet has overcome a major issue in the internet of things environment. The major issue is that there are many competing protocols and standards around the way sensors talk to the server. It is unfeasible to create the intelligence in the server to handle all of these different protocols and also if the approach was to send everything to the server and determine at the server side it would consume considerable bandwidth. By leveraging IPFIX the present inventors unify all these competing standards into one standard out on the network edge before sending it up to the server. This enables huge scale and flexibility in the server and huge savings in bandwidth. A connection layer 116 provides a proxy which handles the complexities of communicating interface modules 101 and the communication module 110. This is a common abstraction method used in software to ensure that modules only focus on doing what their job is. The connection layer 116 talks to interfaces 101 through an API.

The cache 111 stores sensed data and provides a temporary memory buffer on the IoT gateway device 101. The flow inclusion module 106 performs a flow inclusion decision. This operation is where newly sensed data is passed through and compared to the last sensed data for a particular sensor 106. The last sensed data is held in the cache 111. If the data has not changed then there is no need to send it to the central server 150. This reduces bandwidth and therefore reduces data transmission costs. The newly sensed data then replaces the last data and the operation is repeated when data is retrieved from the sensors 102 again. In the case where the gateway device 102 goes out of coverage and cannot send data back to the central server then data starts to get buffered in the cache 111. The amount of data that can fit in this buffer varies based on the memory resources available on the gateway device 100. The cache 111 is intelligent in that it can sense the memory available and takes actions such as removing duplicates and dropping records based on priority to ensure the best use of the memory available. When the device comes back into coverage the contents of the buffer is then forwarded to the central server 150.

The method with which the sensed data is sent back to the central server uses the IPFIX protocol. The records are constructed in the exporter module 112 and received on the central server 150 by the gateway interface 115. This data is then decoded and stored to the long term database 118. The cache 111 is not persistent across router reboots. In otherwords the contents in the cache 111 is deleted during a reboot of the gateway device 100.

The database 107 is installed on the gateway device 100 during the provisioning phase of the gateway device 100. It is initially empty or just a shell. An interface module 101 which is installed on the gateway device 100 sends a message through a connector application programming interface, this is a discovery call which informs the processing modules 105 of the new sensors 102 that the interface module 101 intends to send data for and the semantics (template data) around each sensor value. The processing module 105 inspects the database 107 and generates a unique template identifier for each sensor value and passes this back to the interface module 101. This also creates a template definition record in the database 107. The interface module 1 is configured to keep track of the association between sensor values and template identifiers. Once this initialisation process is complete, each sensor data value that is received by the interface module 101 is stamped with the template identifier. The database 107 stores descriptive information about the data with which the IoT gateway device 100 is expected to sense from the sensors 102. For example for a sensor 102 that senses temperature it will state that this is degrees Celsius, an integer, an absolute value, above 50 may be undesirable etc. This is persisted across reboots. In otherwords, the contents of the database 107 is retained during a reboot of the gateway device 100. Changes to this are synced with the central server 150 using HTTP(S). When synced the new templates reside on the central server in the database 122.

The methods for creating interface modules 101 on the gateway device 100 is determined by the technologies available on the gateway device 100. Some gateway devices are very open and facilitate the upload of whatever drivers or binary files required. Thus the gateway devices 100 are configurable. This is the desired situation as it facilitates the upload of driver or writable applications using favoured object oriented languages such as Java or C++. In cases where the system is more locked down and you cannot upload binaries one can port the functionality over to a scripting language such as tool command language (Tel). In both cases the logic inside needs to accomplish two things. Firstly to establish communication to a sensor. In the case of some sensors there is a set up phase where it is necessary to query the sensor and potentially supply some parameters before the data will be returned. This is akin to interrogation of the sensor. Alternatively, the interface modules 101 are configured to listen on a particular port and data is automatically received from the sensor 102. The second major task of the interface module 101 is to decode the received data, pull out the individual sensed values and pass them and their template identifier along to the processing module 105. This way they can then be considered candidates for exporting to the central server 150.

The sensors 102 may include any desired sensors. Examples of four sensor types are described as follows by way of example. A J1939 sensor is used to talk the engines to pull telematics data from heavy goods vehicles (HGV) vehicles. The sensor is connected to the J1939 port on the vehicle and at the other end a serial connection is connected to the IoT gateway serial port. The interface module 101 on the IoT gateway device 100 is programmed so it knows which values to look for from the engine, e.g. miles per hour (MPH), miles per gallon (MPG), throttle position, coolant temperature etc. It is also programmed so it knows how to contact the sensor. To do this the interface module 101 performs what's called a reverse telnet out the serial port which opens a communication channel. It then sends down a series of commands to the sensor 102 to inform it to start sending and sets a filter so it only sends certain values, once this is complete the data is streamed from the sensors 102 back to the interface module 101 which decodes it as it arrives. The decoding functionality knows which value it has just decoded and pairs that with a template identifier identifying which value that is. This is then passed on to the processing module 105 for processing.

An on-board diagnostics (OBD) sensor is used for talking to the engine of small vehicles such as cars. It works similarly to J1939 but with some key differences. Connection to this sensor can be over Ethernet, Wi-Fi or serial. Once communication is established it needs to send some commands down to initialise the sensor 102. When the sensor 102 is initialised it can then be queried. The interface module 101 then queries the OBD sensor 102 at regular intervals to retrieve data. This is the key difference between OBD and J1939. In OBD it's a request/response mechanism and in J1939 once initial setup is done it is just a listen mechanism. The rest of the application works the same as J1939.

A smart agriculture sensor is slightly smarter than a OBD sensor in that it can be programmed as to how it sends its data. In the present teaching the sensor is programmed to send data at regular intervals to the IoT gateway device using simple network management protocol (SNMP) traps. The interface module 101 on the IoT gateway device 100 then listens out for this data by binding to the user datagram protocol (UDP) port and pulls out the sensed value, matches it with its template identifier and forwards on to the processing module 105 for further processing.

A heart rate monitor is a sensor typically worn around the wrist. It transmits data to a transceiver over a sub GHz frequency. The transceiver has a driver associated with it which is loaded onto the IoT gateway device 100. This driver decodes the sensor data and forwards it on to the processing module 105 for further processing.

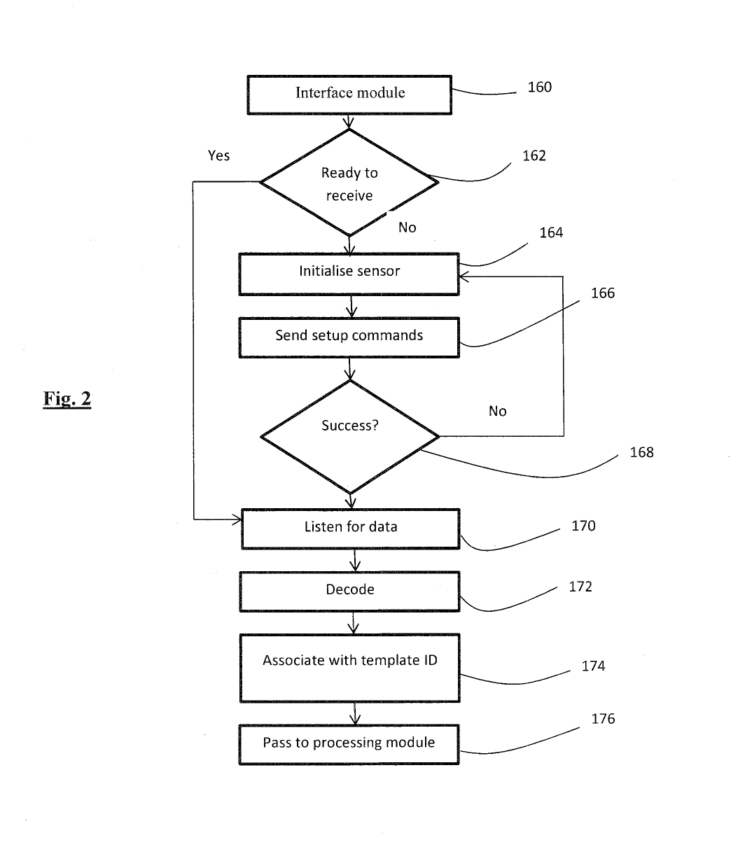

Referring now to the flow chart of FIG. 2 which describes exemplary functions of the interface module 101. The interface module 101 is hosted on the gateway device 100, block 160. The interface module 101 is installed in the run time environment and is therefore active when the gateway device's operating system boots up, block 162. Depending on the application and sensor type the interface module 101 may be ready to receive data straight away. If the interface module 101 is not ready to receive data straight away it needs to perform the necessary setup. This often involves sending a wake up call to the sensor 102 to turn it on and initialise the sensor, block 164. Also there may be further setup commands needed for example to give the sensor 102 further information about what data that is to be received from the sensor 102, block 166. If the attempt to initialise the sensor 102 failed the interface module 101 will retry the operation until it succeeds, block 168. If the interface module is ready to receive data or after initialisation of the sensor 102, the interface module 101 then binds to whatever port it needs to and listens for data coming in from the sensor 102, step 170. Data that is received is then decoded according to the specification of whatever the sensor protocol is, step 172. The interface module 101 that decoded the sensor data also knows the template identifiers and matches them up, block 174. The template identifiers are then passed to the processing module 105, block 176.

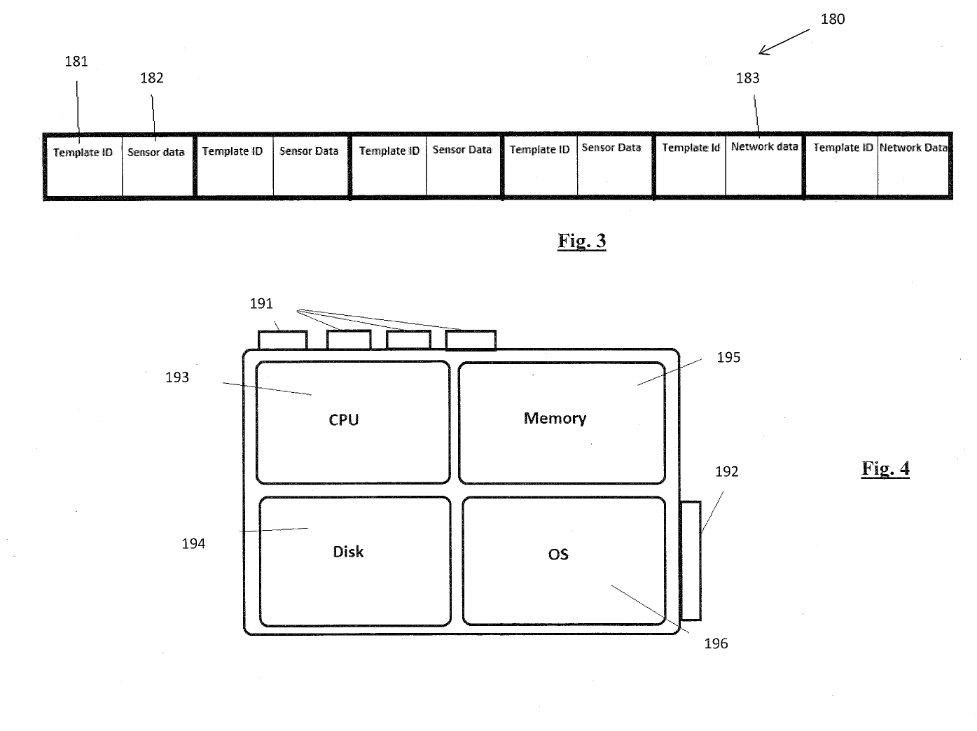

Referring now to FIG. 3 which illustrates an exemplary message 180 which is generated by the device 100. Each sensor data value which is received from the sensors 102 is stamped with a template identifier (ID) 181. The template ID 181 is generated by the interface module 101 which has learned what the template id should be for each sensor value that it sends to the processing module 105. Typically, there are two types of data, sensor data 182 and network data 183. Sensor data 182 is obtained by the interface modules 101 talking to external sensors 102 and is generated in response to the sensor 102 sensing a stimulus. Sensor data 182 depend on the environment where the gateway device 101 is operating, for example, in a vehicle the sensor data 181 could be MPH or RPM, in a smart city environment they could be temperature, humidity and dust concentration. Network data 183 is data that is sourced internally in the gateway device 101 from the network management module 110, this data will stay the same in all environments. It is related to the quality of the network connection on the gateway device 100. On the server side the message 180 arrives to the gateway interface 115. The gateway interface 115 is configured to listen for messages coming in from a particular port. The message 180 is then forwarded to template transformation layer 116 which inspects the message 180, first pulling out the template id and matching this with the template id from the server side database 122. It then knows how to decode the value following the template id, e.g., integer, double, string etc. Once decoded the values are forwarded to the database 118.

Referring now to FIG. 4, there is illustrated the primary hardware elements which are provided on the gateway device 100. Sensor interfaces 191 are built into gateway device 100. Example, of the sensor interface 190 may include serial, ethernet, Wi-Fi, Bluetooth, Sub GHz frequency transceivers, 2.4 GHZ transceivers etc. A backhaul interface 192 provide a way for the gateway device 100 of obtaining information from a remote location back to a data centre where the central server 150 is located. The backhaul interface 192 can be cellular or if network infrastructure is available it can be plugged into a wired platform, for example, an optical fibre network. A central processing unit 193 provides the processing capabilities on the gateway device 100 and processes all of the instructions that the gateway device 100 is programmed to undertake. A memory disk 194 is provided for storing anything that needs to be stored persistently is stored. In the exemplary arrangement the database 107 is stored on the disk 194 to survive rebooting of the gateway device 100. Memory 195 is where volatile information is stored. The cache 111 of sensor data 182 is stored here. The database 107 is loaded into memory 194 for quick access by the operating system 196 installed on the gateway device 100. The central server 150 may be provided on a cloud platform. If an organization has already invested in existing servers and systems it is envisaged that the central server 150 could be provided as part of an on-premise solution deployed behind a firewall.

It will be understood that what has been described herein is an exemplary IoT system. While the present teaching has been described with reference to exemplary arrangements it will be understood that it is not intended to limit the teaching to such arrangements as modifications can be made without departing from the spirit and scope of the present teaching.

It will be understood that while exemplary features of a IoT system in accordance with the present teaching have been described that such an arrangement is not to be construed as limiting the invention to such features. The method of the present teaching may be implemented in software, firmware, hardware, or a combination thereof

Generally, in terms of hardware architecture, such a IoT gateway device will include, as will be well understood by the person skilled in the art, a processor(s), memory, and one or more input and/or output (I/O) devices. The processor(s) may be programmed to perform the functions of the modules as described above. The processor(s) is a hardware device for executing software, particularly software stored in memory. Processor(s) can be any custom made or commercially available processor, a central processing unit (CPU), an auxiliary processor among several processors associated with a computer, a semiconductor based microprocessor (in the form of a microchip or chip set), a macroprocessor, or generally any device for executing software instructions.

Memory is associated with processor(s) and can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor(s).

The software in memory may include one or more separate programs. The separate programs comprise ordered listings of executable instructions for implementing logical functions in order to implement the functions of the modules. In the example of heretofore described, the software in memory includes the one or more components of the method and is executable on a suitable operating system (O/S).

The present disclosure may include components provided as a source program, executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, a methodology implemented according to the teaching may be expressed as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada.

When the method is implemented in software, it should be noted that such software can be stored on any computer readable medium for use by or in connection with any computer related system or method. In the context of this teaching, a computer readable medium is an electronic, magnetic, optical, or other physical device or means that can contain or store a computer program for use by or in connection with a computer related system or method. Such an arrangement can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. Any process descriptions or blocks in the Figures, should be understood as representing modules, segments, or portions of code which include one or more executable instructions for implementing specific logical functions or steps in the process, as would be understood by those having ordinary skill in the art.

It should be emphasized that the above-described embodiments of the present teaching, particularly, any “preferred” embodiments, are possible examples of implementations, merely set forth for a clear understanding of the principles. Many variations and modifications may be made to the above-described embodiment(s) without substantially departing from the spirit and principles of the present teaching. All such modifications are intended to be included herein within the scope of this disclosure and the present invention and protected by the following claims.

While the present teaching has been described with reference to exemplary applications and modules it will be understood that it is not intended to limit the teaching of the present teaching to such arrangements as modifications can be made without departing from the spirit and scope of the present invention. It will be appreciated that the system may be implemented using cloud or local server architecture. In this way it will be understood that the present teaching is to be limited only insofar as is deemed necessary in the light of the appended claims.

Similarly the words comprises/comprising when used in the specification are used to specify the presence of stated features, integers, steps or components but do not preclude the presence or addition of one or more additional features, integers, steps, components or groups thereof.

1. A gateway device for an internet-of-things environment, the gateway device comprising:
a sensor interface for interfacing with a plurality of sensors;
a first memory unit for storing sensed data received from the sensors;
a second memory unit for storing template data associated with the sensors which is generated by the sensor interface;
a processing module configured for generating encoded messages associated with the respective sensors containing the sensed data and the template data; and
a communication module for communicating the encoded messages to a central server for decoding.

2. A gateway device as claimed in claim 1, wherein the contents of the first memory unit is deleted during a reboot of the gateway device.

3. A gateway device as claimed in claim 1, wherein the contents of the second memory unit is retained during a reboot of the gateway device.

4. A gateway device as claimed in claim 1, wherein the processing module is further configured for comparing current sensor data against previous sensor data stored in the first memory unit for determining output data.

5. A gateway device as claimed in claim 4, wherein the comparison step is implemented in real-time.

6. A gateway device as claimed in claim 4, wherein the encoded messages contain the output data.

7. A gateway device as claimed in claim 1, wherein the encoded messages are compatible with an internet protocol flow information export (IPFIX) format.

8. A gateway device as claimed in claim 1, wherein the sensor interface is configured to interrogate the sensors for retrieving sensed data therefrom.

9. A gateway device as claimed in claim 1, wherein the sensor interface is configured to listen for data output by the sensor.

10. A gateway device as claimed in claim 8, wherein the sensor interface is operable to interrogate the sensors for retrieving data therefrom.

11. A gateway device as claimed in claim 1, wherein the sensor interface comprises a plurality of interface modules for interfacing with a plurality of sensors.

12. A gateway device as claimed in claim 11, wherein two or more of the interface modules are configured for communicating with sensors having different communication protocols.

13. A gateway device as claimed in claim 11, wherein the respective interface modules comprise a binary library.

14. A gateway device as claimed in claim 11, wherein the respective interface modules comprise a script.

15. A gateway device as claimed in claim 11, wherein the respective interface modules for configurable for facilitating writing data thereto.

16. A gateway device as claimed in claim 13, wherein the respective interface modules retrieve raw sensor data from corresponding sensors.

17. A gateway device as claimed in claim 16, wherein the respective interface modules pass the raw sensor data into their associated binary library via an application programming interface.

18. A gateway device as claimed in claim 11, wherein the respective interface modules publish the raw sensor data and template data to a discovery layer.

19. A gateway device as claimed in claim 18, wherein the template data for the respective sensors are provided in corresponding descriptor files.

20. A gateway device as claimed in claim 19, wherein the respective descriptor files include one or more of the following pieces of data type, units, labels, and descriptive text.

21. A gateway device as claimed in claim 20, wherein the template data has an associated identifier for each sensor value.

22. A gateway device as claimed in claim 1, wherein the encoded messages are communicated to the central server using a hypertext transfer protocol (HTTP).

23. A gateway device as claimed in claim 1, wherein the processing module is operable to receive information from multiple interface modules each communicable with a corresponding sensor.

24. A gateway device as claimed in claim 4, wherein the processor module is configured to selectively filter raw sensor data for determining the output data.

25. A gateway device as claimed in claim 24, wherein the output data includes only sensor values which have changed since a previous sensor reading.

26. A gateway device as claimed in claim 1, wherein encoded messages are synchronised with a remote central database at predetermined time intervals.

27. A gateway device as claimed in claimed 23, wherein the processing module has associated configuration data.

28. A gateway device as claimed in claim 26, wherein the configuration data includes threshold values for determining when to generate alerts.

29. A gateway device as claimed in claim 26, wherein the configuration data includes a time schedule for determining how regularly to synchronise the encoded messages with the central database.

30. A gateway device as claimed in claim 26, where the configuration data includes information for determining when to synchronise the encoded messages with the central database.

31. A gateway device as claimed in claim 26, wherein the configuration data includes details of specific actions to implement if a threshold is exceeded.

32. A gateway device as claimed in claim 1, wherein a predictive analysis module provides an intelligent service for predicting issues with sensors.

33. A gateway device as claimed in claim 1, wherein a thresholding parameters module is configured to compare raw sensor data against threshold values.

34. A gateway device as claimed in claim 32, wherein the thresholding parameters module generates an appropriate alert message if a threshold value is exceeded.

35. A gateway device as claimed in claim 33, wherein the communication module is configured to transmit the generated alert message to the central server for initiating a course of actions.

36. A gateway device as claimed in claim 34, wherein the communication module is operable to monitor the signal strength of a cellular network.

37. A gateway device as claimed in claim 35, wherein if the signal strength deviates below an acceptable level the output data is buffered until the signal strength increases above the acceptable level.

38. A gateway device as claimed in claim 36, wherein the output data is buffered in the short term memory unit.

39. A gateway device as claimed in claim 37, wherein the first memory unit includes a mechanism for preventing the information contained therein exceeding a limit.

40. A gateway device as claimed in claim 38, wherein the mechanism deletes data in the first memory unit if the buffered output data exceeds the limit.

41. A gateway device as claimed in claim 39, wherein the mechanism deletes data according to a set of priority rules.

42. A gateway device as claimed in claim 1, wherein the communication module includes a subscriber identify module.

43. A gateway device as claimed in claim 1, wherein the communication module is operable to select an access point name (APN) for communicating the gateway device and the central server.

44. A gateway device as claimed in claim 1, wherein the communication module is operable to send data to the central server via a short message service (SMS).

45. A gateway device as claimed in claim 6, wherein the encoded messages contain a flag to indicate that an acknowledgement is required when received at the central server.

46. A gateway device as claimed in claim 44, wherein the communication module is configured to resend the encoded message if an acknowledgement is not received from the central server within a predetermined time limit.

47. A central server for an internet-of-things environment; the central server comprising:
a gateway interface for interfacing with a plurality of gateway devices;
a central database comprising records of sensors associated with the respective gateway devices; the records including sensed data and template data received from the respective gateway devices;
a synchronisation module configured for facilitating the synchronisation of the central database with the respective gateway devices; and
a synchronisation module configured for facilitating the synchronisation of the central database with the respective gateway devices; and
a processing module for controlling the respective gateway devices.

48. A central server as claimed in claim 46, wherein the gateway interface is configured to decode the output data received from the respective gateway devices.

49. A central server as claimed in claim 47, wherein the gateway interface is operable to parse IPFIX messages received from the respective gateway devices.

50. A central server as claimed in claim 46, further comprising a predictive analysis module which is configured to compare data patterns for predicting sensor faults.

51. A central server as claim in claim 49, wherein the processing module is operable to transmit updates to the respective gateway devices if a sensor fault is predicted.

52. A central server as claimed in claim 46, wherein the central server is provided on the cloud.

53. An internet-of-things (IoT) system comprising:
a plurality of gateway devices which comprise
a sensor interface for communicating with a plurality of sensors;
a local database for storing records associated with the respective sensors;
the records include sensed data and template data;
a gateway synchronising module configured for synchronising the local database with a remote central database associated with a central server; and
a communication module for communicating data between the gateway device and the central server,
the IoT system further comprising:
a central server comprising:
a gateway interface for interfacing with the plurality of gateway devices;
a central database comprising records of sensors associated with the respective gateway devices; the records including sensed data and template data;
a server synchronisation module being co-operable with the gateway synchronising module; and
a controlling module for controlling the respective gateway devices.
